(19) United States
(12) Patent Application Publication
(10) Pub. No.: US 2025/0130853 A1
(43) Pub. Date: Apr. 24, 2025

(54) Orchestration of Requests with Intent Valet

(71) Applicant: VMware LLC, Palo Alto, CA (US)

(72) Inventors: VIPUL PATEL, Bangalore (IN); BHAVESH SHARMA, Bangalore (IN); MANJUNATH BANDI, Bangalore (IN)

(21) Appl. No.: 18/607,338

(22) Filed: Mar. 15, 2024

(30) Foreign Application Priority Data
Oct. 18, 2023 (IN) 202341071002

(51) Int. Cl. G06F 9/48

(52) U.S. Cl. CPC G06F 9/4881

(57) ABSTRACT

System and computer-implemented method for processing operation requests in a computing environment uses an intent for an operation request received at a service instance that is submitted to an intent valet platform to process the operation request. The intent is queued in an intent table of intents and then retrieved for processing. The requested operation for the retrieved intent is delegated to the service for execution from the intent valet platform. When a completion signal from the service is received at the intent valet platform, the intent is marked as being in a terminal state.

### CROSS-REFERENCES

This application claims the benefit of Indian Patent Application number 202341071002, entitled “ORCHESTRATION OF REQUESTS WITH INTENT VALET,” filed on Oct. 18, 2023, of which is hereby incorporated by reference in its entirety.

### BACKGROUND

Cloud architectures are used in cloud computing and cloud storage systems for offering infrastructure-as-a-service (IaaS) cloud services. Examples of cloud architectures include the VMware Cloud architecture software, Amazon EC2™ web service, and OpenStack™ open source cloud computing service. IaaS cloud service is a type of cloud service that provides access to physical and/or virtual resources in a cloud environment. These services provide a tenant application programming interface (API) that supports operations for manipulating IaaS constructs, such as virtual computing instances (VCIs), e.g., virtual machines (VMs), and logical networks.

A cloud system may aggregate the resources from both private and public clouds. A private cloud can include one or more customer data centers (referred to herein as “on-premise data centers”). A public cloud can include a multi-tenant cloud architecture providing IaaS cloud services. In a cloud system, it is desirable to support VCI migration between different private clouds, between different public clouds and between a private cloud and a public cloud for various reasons, such as workload management. Such VCI migrations may involve various operations that operate on the same objects in the cloud system, which may cause conflicts and/or errors if not properly processed.

### SUMMARY

System and computer-implemented method for processing operation requests in a computing environment uses an intent for an operation request received at a service instance that is submitted to an intent valet platform to process the operation request. The intent is queued in an intent table of intents and then retrieved for processing. The requested operation for the retrieved intent is delegated to the service for execution from the intent valet platform. When a completion signal from the service is received at the intent valet platform, the intent is marked as being in a terminal state.

A computer-implemented method for processing operation requests in a computing environment in accordance with an embodiment of the invention comprises receiving an operation request at a service instance running in the computing environment, submitting the request to an intent valet platform to process the operation request, creating an intent for the operation request in the intent valet platform, wherein the intent specifies a requested operation in the operation request, queuing the intent in an intent table of intents, retrieving the intent from the intent table for processing, delegating the requested operation for the retrieved intent to the service for execution from the intent valet platform, and marking the intent as being in a terminal state when a completion signal from the service is received at the intent valet platform. In some embodiments, the steps of this method are performed when program instructions contained in a computer-readable storage medium are executed by one or more processors.

A system in accordance with an embodiment of the invention comprises memory and one or more processors configured to receive an operation request at a service instance running in the computing environment, submit the operation request to an intent valet platform to process the operation request, create an intent for the operation request in the intent valet platform, wherein the intent specifies a requested operation in the operation request, queue the intent in an intent table of intents, retrieve the intent from the intent table for processing, delegate the requested operation for the retrieved intent to the service for execution from the intent valet platform, and mark the intent as being in a terminal state when a completion signal from the service is received at the intent valet platform.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a cloud system in which embodiments of the invention may be implemented.

FIG. 2 is a diagram that shows the state machine of an intent in accordance with an embodiment of the invention.

FIG. 3 shows components of an intent valet platform in the cloud system in accordance with an embodiment of the invention.

FIG. 4 shows interfaces and relationships between a business microservice and the intent valet platform in accordance with an embodiment of the invention.

FIG. 5 shows a sequence diagram of an intent valet initialization process to use the intent valet platform in accordance with an embodiment of the invention.

FIG. 6 shows a sequence diagram of a process of admitting a request from a service instance into the intent valet platform as an intent in accordance with an embodiment of the invention.

FIG. 7 shows a sequence diagram of processing queued intents in the intent valet platform in accordance with an embodiment of the invention.

FIG. 8 shows a diagram of an end-to-end event sequence of using the intent valet platform in accordance with an embodiment of the invention.

FIG. 9 is a process flow diagram of a computer-implemented method for processing operation requests in a computing environment in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

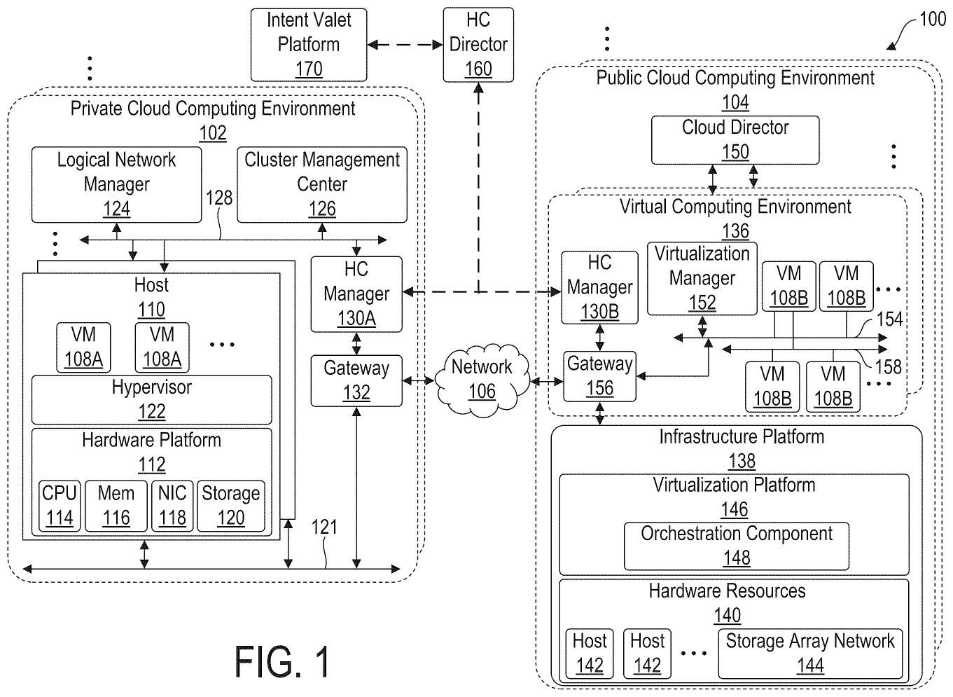

Turning now to FIG. 1, a block diagram of a cloud system 100 in which embodiments of the invention may be implemented in accordance with an embodiment of the invention is shown. The cloud system 100 includes one or more private cloud computing environments 102 and one or more public cloud computing environments 104 that are connected via a network 106. The cloud system 100 is configured to provide a common platform for managing and executing workloads seamlessly between the private and public cloud computing environments. Thus, the cloud system 100 is a multi-cloud computing environment. In one embodiment, one or more private cloud computing environments 102 may be controlled and administrated by a particular enterprise or business organization, while one or more public cloud computing environments 104 may be operated by a cloud computing service provider and exposed as a service available to account holders, such as the particular enterprise in addition to other enterprises. In some embodiments, one or more private cloud computing environments 102 may form a private or on-premise software-defined data center (SDDC). In other embodiments, the on-premise SDDC may be extended to include one or more computing environments in one or more public cloud computing environments 104. Thus, as used herein, SDDCs refers to SDDCs that are formed from multiple cloud computing environments, which may be form by multiple private cloud computing environments, multiple public cloud computing environments or any combination of private and public cloud computing environments.

The private and public cloud computing environments 102 and 104 of the cloud system 100 include computing and/or storage infrastructures to support a number of virtual computing instances 108A and 108B. As used herein, the term “virtual computing instance” refers to any software processing entity that can run on a computer system, such as a software application, a software process, a virtual machine (VM), e.g., a VM supported by virtualization products of VMware, Inc., and a software “container”, e.g., a Docker container. However, in this disclosure, the virtual computing instances will be described as being virtual machines, although embodiments of the invention described herein are not limited to virtual machines.

In an embodiment, the cloud system 100 supports migration of the virtual machines 108A and 108B between any of the private and public cloud computing environments 102 and 104. The cloud system 100 may also support migration of the virtual machines 108A and 108B between different sites situated at different physical locations, which may be situated in different private and/or public cloud computing environments 102 and 104 or, in some cases, the same computing environment.

As shown in FIG. 1, each private cloud computing environment 102 of the cloud system 100 includes one or more host computer systems (“hosts”) 110. The hosts may be constructed on a server grade hardware platform 112, such as an x86 architecture platform. As shown, the hardware platform of each host may include conventional components of a computing device, such as one or more processors (e.g., CPUs) 114, system memory 116, a network interface 118, storage system 120, and other I/O devices such as, for example, a mouse and a keyboard (not shown). The processor 114 is configured to execute instructions, for example, executable instructions that perform one or more operations described herein and may be stored in the memory 116 and the storage 120. The memory 116 is volatile memory used for retrieving programs and processing data. The memory 116 may include, for example, one or more random access memory (RAM) modules. The network interface 118 enables the host 110 to communicate with another device via a communication medium, such as a network 121 within the private cloud computing environment. The network interface 118 may be one or more network adapters, also referred to as a Network Interface Card (NIC). The storage 120 represents local storage devices (e.g., one or more hard disks, flash memory modules, solid state disks and optical disks), which may be used as part of a virtual storage area network.

Each host 110 may be configured to provide a virtualization layer that abstracts processor, memory, storage and networking resources of the hardware platform 112 into the virtual computing instances, e.g., the virtual machines 108A, that run concurrently on the same host. The virtual machines run on top of a software interface layer, which is referred to herein as a hypervisor 122, that enables sharing of the hardware resources of the host by the virtual machines. One example of the hypervisor 122 that may be used in an embodiment described herein is a VMware ESXi™ hypervisor provided as part of the VMware vSphere® solution made commercially available from VMware, Inc. The hypervisor 122 may run on top of the operating system of the host or directly on hardware components of the host. For other types of virtual computing instances, the host may include other virtualization software platforms to support those virtual computing instances, such as Docker virtualization platform to support software containers.

Each private cloud computing environment 102 includes at least one logical network manager 124 (which may include a control plane cluster), which operates with the hosts 110 to manage and control logical overlay networks in the private cloud computing environment 102. As illustrated, the logical network manager communicates with the hosts using a management network 128. In some embodiments, the private cloud computing environment 102 may include multiple logical network managers that provide the logical overlay networks. Logical overlay networks comprise logical network devices and connections that are mapped to physical networking resources, e.g., switches and routers, in a manner analogous to the manner in which other physical resources as compute and storage are virtualized. In an embodiment, the logical network manager 124 has access to information regarding physical components and logical overlay network components in the private cloud computing environment 102. With the physical and logical overlay network information, the logical network manager 124 is able to map logical network configurations to the physical network components that convey, route, and filter physical traffic in the private cloud computing environment. In a particular implementation, the logical network manager 124 is a VMware NSX® Manager™ product running on any computer, such as one of the hosts 110 or VMs 108A in the private cloud computing environment 102.

Each private cloud computing environment 102 also includes at least one cluster management center (CMC) 126 that communicates with the hosts 110 via the management network 128. In an embodiment, the cluster management center 126 is a computer program that resides and executes in a computer system, such as one of the hosts 110, or in a virtual computing instance, such as one of the virtual machines 108A running on the hosts. One example of the cluster management center 126 is the VMware vCenter Server® product made available from VMware, Inc. The cluster management center 126 is configured to carry out administrative tasks for the private cloud computing environment 102, including managing the hosts in one or more clusters, managing the virtual machines running within each host, provisioning virtual machines, deploying virtual machines, migrating virtual machines from one host to another host, and load balancing between the hosts.

Each private cloud computing environment 102 further includes a hybrid cloud (HC) manager 130A that is configured to manage and integrate computing resources provided by the private cloud computing environment 102 with computing resources provided by one or more of the public cloud computing environments 104 to form a unified “hybrid” computing platform. The hybrid cloud manager is responsible for migrating/transferring virtual machines between the private cloud computing environment and one or more of the public cloud computing environments, and perform other “cross-cloud” administrative tasks. In one implementation, the hybrid cloud manager 130A is a module or plug-in to the cluster management center 126, although other implementations may be used, such as a separate computer program executing in any computer system or running in a virtual machine in one of the hosts 110. One example of the hybrid cloud manager 130A is the VMware® HCX™ product made available from VMware, Inc.

In one embodiment, the hybrid cloud manager 130A is configured to control network traffic into the network 106 via a gateway device 132, which may be implemented as a virtual appliance. The gateway device 132 is configured to provide the virtual machines 108A and other devices in the private cloud computing environment 102 with connectivity to external devices via the network 106. The gateway device 132 may manage external public Internet Protocol (IP) addresses for the virtual machines 108A and route traffic incoming to and outgoing from the private cloud computing environment and provide networking services, such as firewalls, network address translation (NAT), dynamic host configuration protocol (DHCP), load balancing, and virtual private network (VPN) connectivity over the network 106.

Each public cloud computing environment 104 of the cloud system 100 is configured to dynamically provide an enterprise (or users of an enterprise) with one or more virtual computing environments 136 in which an administrator of the enterprise may provision virtual computing instances, e.g., the virtual machines 108B, and install and execute various applications in the virtual computing instances. Each public cloud computing environment includes an infrastructure platform 138 upon which the virtual computing environments can be executed. In the particular embodiment of FIG. 1, the infrastructure platform 138 includes hardware resources 140 having computing resources (e.g., hosts 142), storage resources (e.g., one or more storage array systems, such as a storage area network 144), and networking resources (not illustrated), and a virtualization platform 146, which is programmed and/or configured to provide the virtual computing environments 136 that support the virtual machines 108B across the hosts 142. The virtualization platform may be implemented using one or more software programs that reside and execute in one or more computer systems, such as the hosts 142, or in one or more virtual computing instances, such as the virtual machines 108B, running on the hosts.

In one embodiment, the virtualization platform 146 includes an orchestration component 148 that provides infrastructure resources to the virtual computing environments 136 responsive to provisioning requests. The orchestration component may instantiate virtual machines according to a requested template that defines one or more virtual machines having specified virtual computing resources (e.g., compute, networking and storage resources). Further, the orchestration component may monitor the infrastructure resource consumption levels and requirements of the virtual computing environments and provide additional infrastructure resources to the virtual computing environments as needed or desired. In one example, similar to the private cloud computing environments 102, the virtualization platform may be implemented by running on the hosts 142 VMware ESXi™-based hypervisor technologies provided by VMware, Inc. However, the virtualization platform may be implemented using any other virtualization technologies, including Xen®, Microsoft Hyper-V® and/or Docker virtualization technologies, depending on the virtual computing instances being used in the public cloud computing environment 104.

In one embodiment, each public cloud computing environment 104 may include a cloud director 150 that manages allocation of virtual computing resources to an enterprise. The cloud director may be accessible to users via a REST (Representational State Transfer) API (Application Programming Interface) or any other client-server communication protocol. The cloud director may authenticate connection attempts from the enterprise using credentials issued by the cloud computing provider. The cloud director receives provisioning requests submitted (e.g., via REST API calls) and may propagate such requests to the orchestration component 148 to instantiate the requested virtual machines (e.g., the virtual machines 108B). One example of the cloud director is the VMware vCloud Director® product from VMware, Inc. The public cloud computing environment 104 may be VMware cloud (VMC) on Amazon Web Services (AWS).

In one embodiment, at least some of the virtual computing environments 136 may be configured as SDDCs. Each virtual computing environment includes one or more virtual computing instances, such as the virtual machines 108B, and one or more cluster management centers 152. The cluster management centers 152 may be similar to the cluster management center 126 in the private cloud computing environments 102. One example of the cluster management center 152 is the VMware vCenter Server® product made available from VMware, Inc. Each virtual computing environment may further include one or more virtual networks 154 used to communicate between the virtual machines 108B running in that environment and managed by at least one networking gateway device 156, as well as one or more isolated internal networks 158 not connected to the gateway device 156. The gateway device 156, which may be a virtual appliance, is configured to provide the virtual machines 108B and other components in the virtual computing environment 136 with connectivity to external devices, such as components in the private cloud computing environments 102 via the network 106. The gateway device 156 operates in a similar manner as the gateway device 132 in the private cloud computing environments. In some embodiments, each virtual computing environment may further include components found in the private cloud computing environments 102, such as the logical network managers, which are suitable for implementation in a public cloud.

In one embodiment, each virtual computing environments 136 includes a hybrid cloud (HC) manager 130B configured to communicate with the corresponding hybrid cloud manager 130A in at least one of the private cloud computing environments 102 to enable a common virtualized computing platform between the private and public cloud computing environments. The hybrid cloud director 130B may communicate with the hybrid cloud manager 130A using Internet-based traffic via a VPN tunnel established between the gateways 132 and 156, or alternatively, using a direct connection (not shown), which may be an AWS Direct Connect connection. The hybrid cloud manager 130B and the corresponding hybrid cloud manager 130A facilitate cross-cloud migration of virtual computing instances, such as virtual machines 108A and 108B, between the private and public computing environments. This cross-cloud migration may include “cold migration”, which refers to migrating a VM which is always powered off throughout the migration process, “hot migration”, which refers to live migration of a VM where the VM is always in powered on state without any disruption, and “bulk migration”, which is a combination where a VM remains powered on during the replication phase but is briefly powered off, and then eventually turned on at the end of the cutover phase. The hybrid cloud managers in different computing environments, such as the private cloud computing environment 102 and the virtual computing environment 136, operate to enable migrations between any of the different computing environments, such as between private cloud computing environments, between public cloud computing environments, between a private cloud computing environment and a public cloud computing environment, between virtual computing environments in one or more public cloud computing environments, between a virtual computing environment in a public cloud computing environment and a private cloud computing environment, etc. As used herein, “computing environments” include any computing environment, including data centers. As an example, the hybrid cloud manager 130B may be a component of the HCX-Enterprise product, which is provided by VMware, Inc.

As shown in FIG. 1, the cloud system 100 further includes a hybrid cloud (HC) director 160, which communicates with multiple hybrid cloud (HC) managers, such as the HC managers 130A and 130B. The HC director 160 aims to enhance operational efficiency by providing a single pane of glass to enable planning and orchestration of workload migration activities across multiple sites, e.g., the private cloud computing environment 102 the virtual computing environment 136, which operate as software-defined data centers (SDDCs). These orchestration activities may include operations like provisioning mobility mesh (set of data path appliances) between the sites, extend/bridge virtual local area network (vLAN) or virtual extensible LAN (VXLAN) to enable workload reachability across the connected sites and migrating a group of VMs. In an embodiment, the HC director may support multiple tenants, and thus, may need to cater to numerous user requests across the various tenant boundaries. Some of these operations may take significant amount of time to conclude. Thus, the HC director should have the ability to accept requests for operations, record the requests and guarantee that registered requests shall be picked up for execution to bring them to a deterministic terminal state (success or failure). In the process of executing a request, which may involve multiple objects, these objects may get consumed and their states could be changed by one or more mutation operations. If multiple requests need to operate on the same set of objects and the requests are allowed to run concurrently, then it can cause inconsistency and indeterministic state of the system. Hence, it becomes essential to identify conflicting requests based on the object dependencies and serialize them accordingly. Moreover, the system should allow non-conflicting requests (i.e., different tenant boundaries or not operating on the common objects) to progress concurrently on available service instances for better concurrency and performance. Also, the HC director should be able to track the requests so that it is possible to probe the state of the requests. Thus, the cloud system 100 includes an intent valet platform 170, which provides these abilities with respect to requests, as described in detail below. The intent valet platform may sometimes be referred to herein as the intent valet system or the system.

The intent valet platform 170 operates on requests for operations in the form of intents. An intent, as used herein, is a self-contained object that encapsulates an operation request specifying the requested operation along with the required input parameters and the object dependency against which an operation is to be performed. The object dependency is captured in the form of a serialization key. Serialization key collectively denotes a set of objects to be operated on by the requested operation captured as intent. Some of the examples are:
1. In case requested operation pertains to migration of workload/VM then VM identity is used as a serialization key to help streamline multiple requests submitted against the same workload/VM.
2. Another example is extending vLAN/VXLAN in which case identity of network is used as serialization key to make sure that not more than one operation ends up mutating the network properties causing inconsistent packet forwarding.
3. The configuration of mobility mesh/data path appliances provisioned between the private and public clouds could be changed via the HC director 160 which in turn affects security, performance and availability of the services offered by the mobility mesh. Any intent that targets to operate on a particular mobility mesh will use mesh identifier as serialization key.
   The intent also encapsulates the state of the system which changes throughout the lifecycle of intent, right from its admission in a system to its execution and eventually to the conclusion.

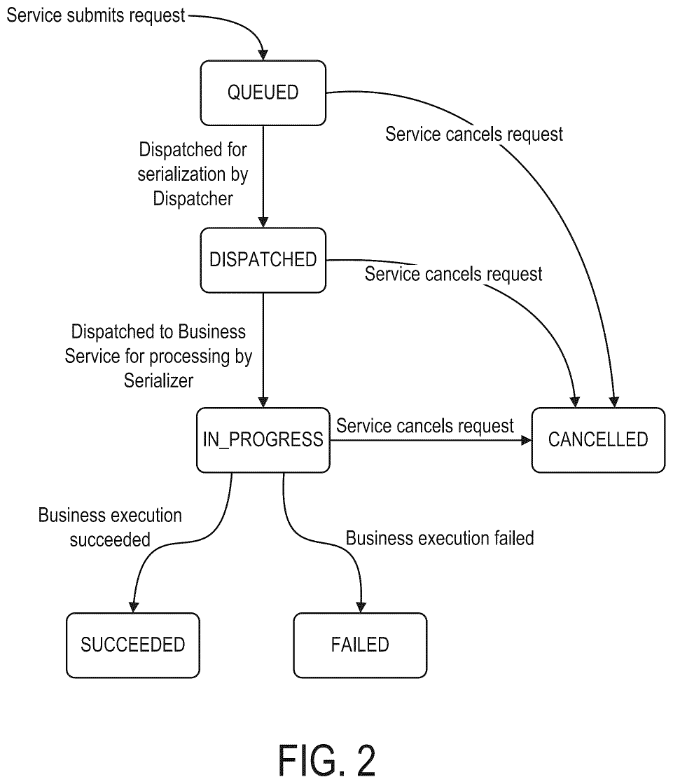

FIG. 2 is a diagram that shows the state machine of an intent in accordance with an embodiment of the invention. As shown in FIG. 2, when a request is submitted by a service, the request is in the QUEUED state. The service may be a microservice provided by the HC director 160. However, the service may be any service running in the cloud system 100. If the request is canceled at any time before completion by the service, then the request is in CANCELLED state. When the request is dispatched for serialization, then the request is in DISPATCHED state. When the request is dispatched to a business service for processing, then the request is in IN_PROGRESS state. If the business execution has succeeded, then the request is in SUCCEEDED state. If the business execution has failed, the request is in FAILED state.

Each service, which can be a microservice, offers one or more functionalities which map to a notion of “operation” in the context of an intent valet.

In an embodiment, the intent schema may be as follows:

```
Type Intent {
  // Platform generated unique ID
  IntentId string
  // Requested operation pertaining to requested intent. To be used by
  service to trigger appropriate business workflow
  OperationType OperationType
  // Caller supplied input params needed to carry out operation
  Input IntentPayload
  // Objects dependency captured as serialization key. Intents operating on
  the same objects shall have same key
  SerializationKey string
  // Current state of the intent
  IntentStatus IntentStatus
  // Microservice that owns the intent
  ServiceName string
  // Tenant for which intent needs to be executed
  TenantId string
  // Meta data suggesting when an intent was created/modified
  CreationDate time.Time
  LastUpdated time.Time
}
```

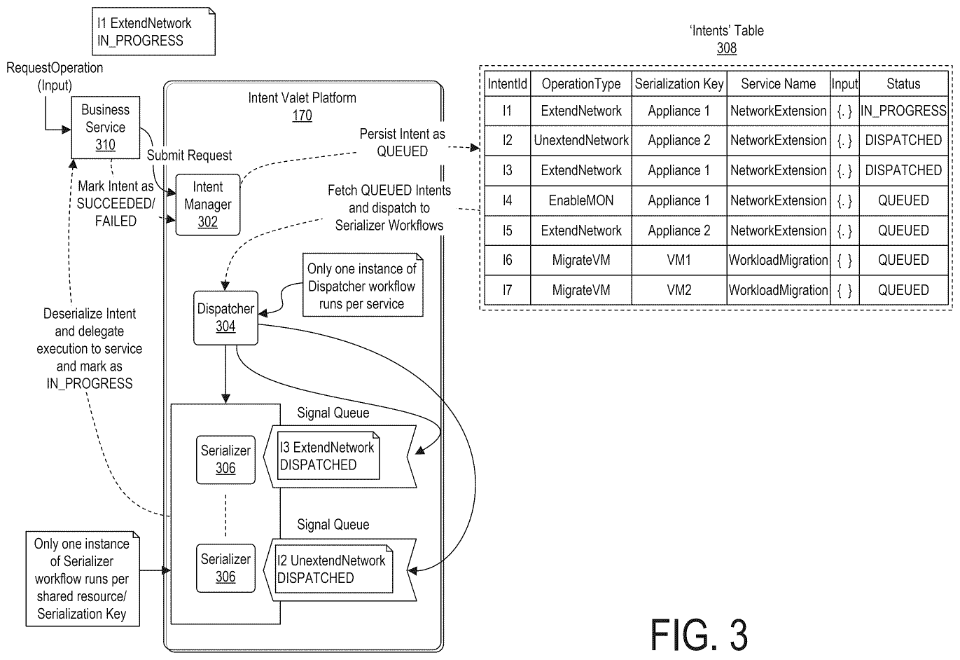

Turning now to FIG. 3, components of the intent valet platform 170 in accordance with an embodiment of the invention are shown. As depicted in FIG. 3, the intent valet platform includes an intent manager 302, a dispatcher 304 and one or more serializers 306, which use a table 308 of intents (“intent table”) to keep track of the state of each intent being handled by the platform. When needed, a business microservice 310, which can be a service running in the HC director 160, consumes the intent valet platform via well-defined interfaces. Also, the consuming service adheres to the service contract defined by the intent valet platform to allow delegation of business functions and inform the consuming service of important events of the intent lifecycle. In other embodiments, the business microservice 310 may be a different service running in a different component. Thus, the business microservice 310 is sometimes referred to herein as a service.

In an embodiment, interfaces for the intent manager and the service may be as follows:

type IntentManager interface {
//Submit - API/Workflow layer in the service to use this semantic for submitting an
intent
Submit(ctx context.Context, operationType OperationType, serializationKey string,
input IntentPayload, opaquePayload interface{ }) (Intent, error)
//MarkIntentAsCompleted - To be used for modifying the status of intent as
COMPLETED. This semantic will be invoked by business functions of services upon
completion of the business logic
MarkIntentAsCompleted(ctx context.Context, intentId string) error
//MarkIntentAsFailed - To be used for modifying the status of intent as FAILED from the
business workflow
MarkIntentAsFailed(ctx context.Context, intentId string) error
//MarkIntentAsCancelled - To be used for modifying the status of intent as CANCELLED
from the business workflow.
// Use this to mark the intent as cancelled after processing has started and service had
handled cancellation scenario appropriately
MarkIntentAsCancelled(ctx context.Context, intentId string) error
//CancelIntent - If intent is in QUEUED state then it will be marked cancelled, otherwise
will return error if the intent is in any other state.
// use this to cancel processing of the intent
CancelIntent(ctx context.Context, intentId string) error
//QueryIntents - query the intents based on the given filter (Filter provides lookup by
OperationType, IntentStatus
QueryIntents(ctx context.Context, filter Filter) (*FilterResponse, error)
}

In an embodiment, every service that leverages the intent valet platform 170 must abide by the following interface to allow platform interaction with the service to delegate execution of business functions and other related operations.

type Service interface {
//GetServiceName - Used by the intent valet platform to fetch service name. This will
be used to create logical isolation in the intent table 308 for every service
GetServiceName( ) string
//IntentPreQueueHook - This provides a service an opportunity to persist data in a
custom table before an intent gets dispatched to the workflow
IntentPreQueueHook(intent intentvalet.Intent, connection *sqlx.Tx) error
//ProcessIntent - Service callback to be exercised by the intent valet platform to
delegate execution of business logic against an intent
ProcessIntent(intent intentvalet.Intent, logger intentvalet.Logger) error
//IntentFailureHook will inform the implementing service of any failure that may have
occurred, while processing the intent
IntentFailureHook(intent intentvalet.Intent, logger intentvalet.Logger)
}

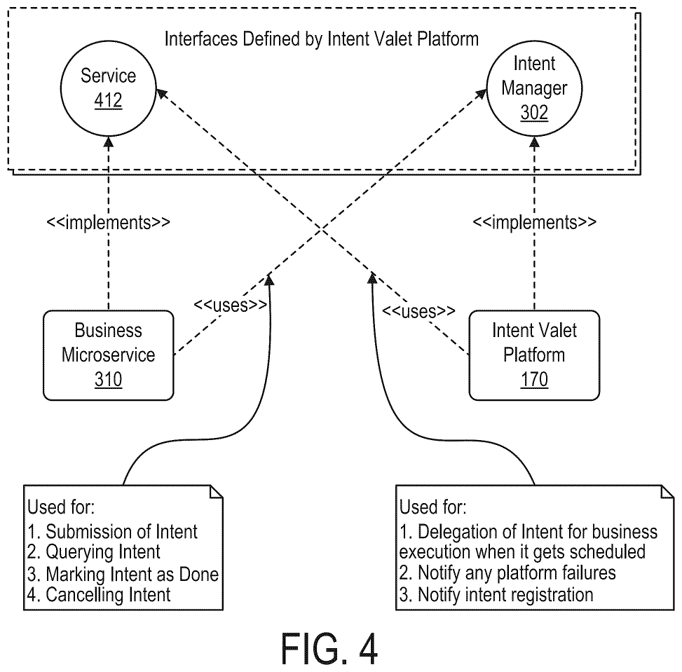

In an embodiment, as illustrated in FIG. 4, the intent valet platform 170 defines interface encapsulating semantics of the platform to be used by the consuming business service 310 for interacting with the intent valet platform. Also, the intent valet platform defines contract that the business service will realize to enable platform to delegate execution of business functions and other aspects to the business service. As illustrated in FIG. 4, the business microservice implements a service 412 and uses the intent manager 302. The interface to the intent manager 302 is used for (1) submission of an intent, (2) querying an intent, (3) concluding an intent, and (4) canceling an intent. The intent valet platform 170 implements the intent manager 302 and interacts with the business microservice 310 via the service 412. The interface to the service 412 is used for (1) delegation of an intent for business execution when the intent gets scheduled, (2) notification of any platform failures, and (3) notification of intent registration.

Turning back to FIG. 3, the intent manager 302 is the primary component of the intent valet platform 170 that exposes intent valet functionalities to services, such as the service 310. The services can use “Submit” semantic of this component to accept an intent without waiting for the intent to get picked up for execution. The submitted intents across various services are registered in the intent table 308. The intents parked in this table await their turn for execution, and until then, the intents remain in the QUEUED state.

After submitting an intent to the intent valet platform 170, the service 310 can go back and perform other functions instead of executing an operation pertaining to the intent immediately. The onus is then on the intent valet platform to schedule the intent as per the right policy and delegate back to the service for execution at a later point in time. The intent manager 302 also provides semantics to query, cancel an intent, and mark an intent as completed when a corresponding business function has concluded.

The service 310 could maintain some additional information about the intent in its persistence layer apart from registering the intent with the intent valet platform 170. Intent acceptance via the “Submit” semantic should be done in an atomic way such that the intent gets registered in the system and at the same time business specific needs of recording information in its persistence layer also happens at the same time. This can be achieved by the “IntentPreQueueHook” semantic exposed by the service. The intent valet platform will invoke this semantic as part of the intent submission pipeline, which provides the service an opportunity to record the information.

The dispatcher 304 of the intent valet platform 170 is responsible for picking up the intents in the QUEUED state from the intent table 308 and delegating to other components of the intent valet platform, i.e., the serializers 306, for scheduling purposes. The dispatcher by itself does not schedule or identify object dependencies of an intent. Rather, the dispatcher ensures that a unique instance of the serializer is instantiated for each set of object dependencies identified by the serialization key of an intent. Subsequently, the dispatcher delegates the intent to the appropriate serializer based on the serialization key of the intent in consideration. Hence, the dispatcher is responsible for the lifecycle management of the serializers and the delegation of each intent to the right serializer.

An intent transitions from the QUEUED state to the DISPATCHED state when the intent lands with the right serializer 306. The intent valet platform 170 ensures that only one instance of the dispatcher 304 runs for each service, independent of multiple instances of the same service. While multiple instances of the service can be added or removed over time, the intent valet platform ensures that at most one instance of the dispatcher is always running in one of these service instances. This component is light weight in nature.

Each serializer 306 of the intent valet platform 170 enables ordering mutually conflicting operations pertaining to received intents. The dispatcher 304 delegates scheduling of conflicting intents to the same instance of the serializer. Each serializer has its own queue where conflicting intents wait for their turn to get picked up.

In operation, a serializer 306 will pick up the first intent from its queue, transitioning that intent from the DISPATCHED state to the IN_PROGRESS state. To carry out actual business functions specific to the intent, the serializer informs corresponding service, e.g., the service 310, via a service callback hook. The service using the intent valet platform 170 will adhere to the prescribed contract, as further described below. The service will inform the serializer of the intent conclusion via the intent manager 302

(MarkIntentAsCompleted/MarkIntentAsFailed/MarkIntentAsCancelled). The intent manager then signals the serializer of this event, which in turn will cause the serializer to pick up the next intent in its queue. Hence, this ensures that the intent does not conflict with its predecessors because those intents operate on the same set of objects.

In an embodiment, each serializer 306 ceases to exist as soon as its queue becomes empty, which implies all mutually conflicting intents have been processed. A new instance of the serializer will be started by the dispatcher 304 if a new set of conflicting intents is admitted in the system subsequently.

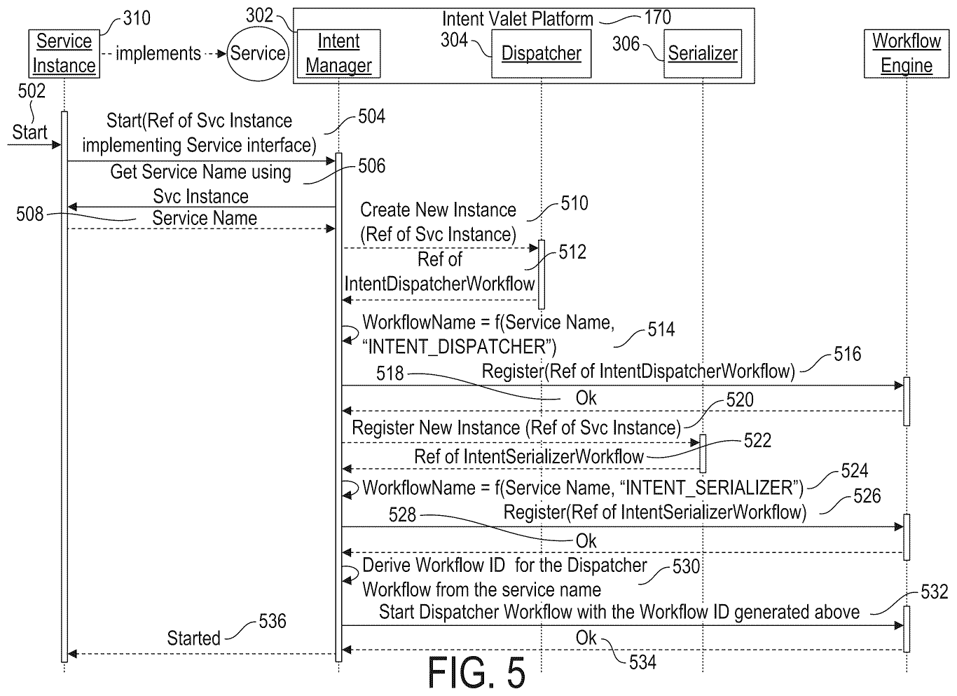

Turning now to FIG. 5, a sequence diagram of an intent valet initialization process to use the intent valet platform 170 in accordance with an embodiment of the invention is shown. In an embodiment, the dispatcher 304 and serializer(s) 306 may be modelled as workflows that could be run on any standard workflow engine. As described below, the specifics of the dispatcher and serializer(s) are not known to the consuming service instance. The intent valet platform registers these platform workflows with a workflow engine, which may be running inside or outside of the intent valet platform.

The intent valet initialization process as shown in FIG. 5 begins at step 502, where a control signal is received by the service instance 310 to start the intent valet initialization process. The service instance implements a service, which may be a microservice provided by the HC director 160. However, the service may be part of any operation being executed by any entity running in any of the private and public cloud computing environments 102 and 104 in the cloud system 100. Next, at step 504, a request to start or use the intent valet platform 170 is made to the intent manager 302 of the intent valet platform. The request may include a reference of the service instance implementing the service interface. Next, at step 506, a request is made to the service instance from the intent manager to get the name of the service. In response, the service name is provided to the intent manager by the service instance, at step 508.

Next, at step 510, a new instance of the dispatcher is created by the intent manager, referencing the service instance 310. Next, at step 512, a reference of the intent dispatcher workflow associated with the dispatcher is sent to the intent manager 302 by the dispatcher 304. In response, at step 514, a workflow name for the dispatcher is defined by the intent manager. In an embodiment, the workflow name is defined as WorkflowName=f (Service Name, “INTENT_DISPATCHER”).

Next, at step 516, the new instance of the dispatcher 304 is registered with the workflow engine by the intent manager 302 with a reference of the intent dispatcher workflow. In response, at step 518, an acknowledgement is transmitted back to the intent manager by the workflow engine.

Next, at step 520, a new instance of the serializer 306 is registered by the intent manager 302, referencing the service instance 310. Next, at step 522, a reference of the intent serializer workflow associated with the serializer is sent to the intent manager by the serializer. In response, at step 524, a workflow name for the serializer is defined by the intent manager. In an embodiment, the workflow name for the serializer is defined as WorkflowName=f (Service Name, “INTENT_SERIALIZER”).

Next, at step 526, the new instance of the serializer 306 is registered with the workflow engine by the intent manager 302 with a reference of the intent serializer workflow. In response, at step 528, an acknowledgement is transmitted back to the intent manager by the workflow engine.

Next, at step 530, a workflow identifier (ID) for the dispatcher workflow is derived from the service name by the intent manager 302. Next, at step 532, an instruction is transmitted to the workflow engine to start the dispatcher workflow with the generated workflow ID by the intent manager. In response, at step 534, an acknowledgement is transmitted back to the intent manager by the workflow engine. Next, at step 536, a message is sent to the service instance 310by the intent manager that the intent valet service has started for the service instance and that the intent valet platform is now ready to accept requests, i.e., intents, from the service instance.

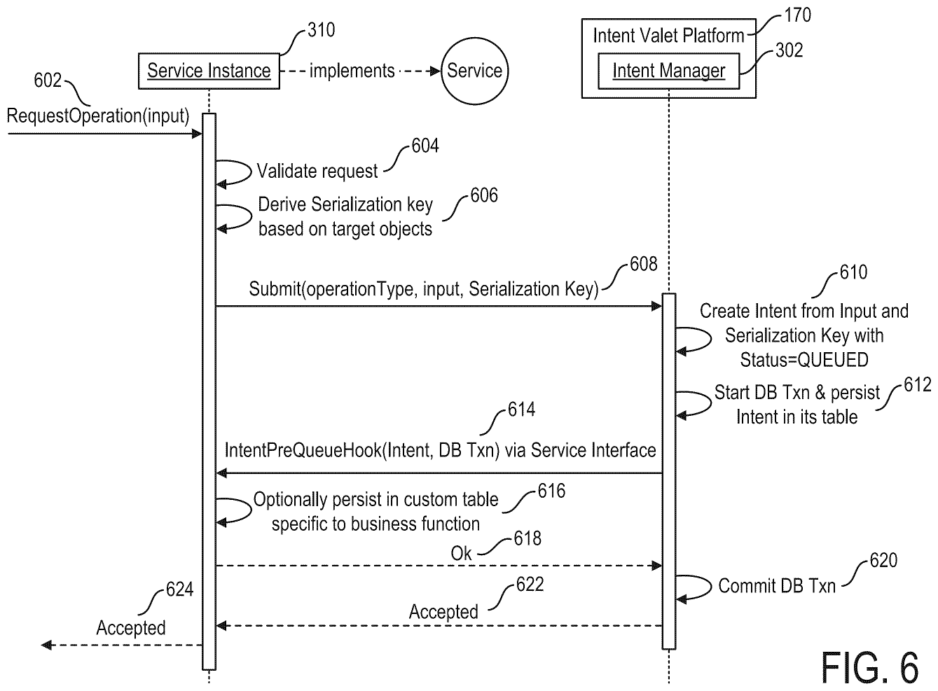

Turning now to FIG. 6, a sequence diagram of a process of admitting a request from the service instance 310 into the intent valet platform 170 as an intent in accordance with an embodiment of the invention is shown. As described below, for this process, the service performs business validation and rejects requests in case of failure. Otherwise, the service reaches out to the intent manager 302 with the supplied input parameters, operation type and the serialization key representing objects dependency of an intent. Hence, the intent gets registered as being in the QUEUED state.

The process as shown in FIG. 6 begins at step 602, where a request is received at the service instance 310 as an input from an originating entity. Next, at step 604, the request is validated by the service instance. In an embodiment, the validations are very specific to the requested business operation and completely agnostic to intent valet platform 170. For example, in the case of a request to migrate VM live, the validation includes checking whether VM is in powered on state. Another example is attempting to delete mobility mesh in which case it needs to ensure that mesh is not in use already. In addition, at step 606, a serialization key is derived by the service instance for the request based on target objects of the request.

Next, at step 608, the request is submitted to the intent manager 302 of the intent valet platform 170 by the service instance 310. In an embodiment, the request includes the operation type, the original input and the serialization key. In response to the request, at step 610, an intent is created by the intent manager from the input and the serialization key with the status set to the QUEUED state. Next, at step 612, a database transaction is started and the intent is persisted in the intent table 308 by the intent manager.

Next, at step 614, a service callback hook (which may be named “IntentPreQueueHook”) is passed to the service instance 310 via the service interface by the intent manager 302. In an embodiment, the IntentPreQueueHook references the intent and the database transaction. Next, at optional step 616, information regarding the intent is persisted in a custom table that is specific to a business function.

Next, at step 618, an acknowledgement is transmitted to the intent manager 302 from the service instance 310. In response, at step 620, the database transaction is committed by the intent manager. Next, at step 622, a message is sent to the service instance from the intent manager that the request has been accepted. Next, at step 624, a similar message is sent to the request originating entity from the service instance that the request has been accepted.

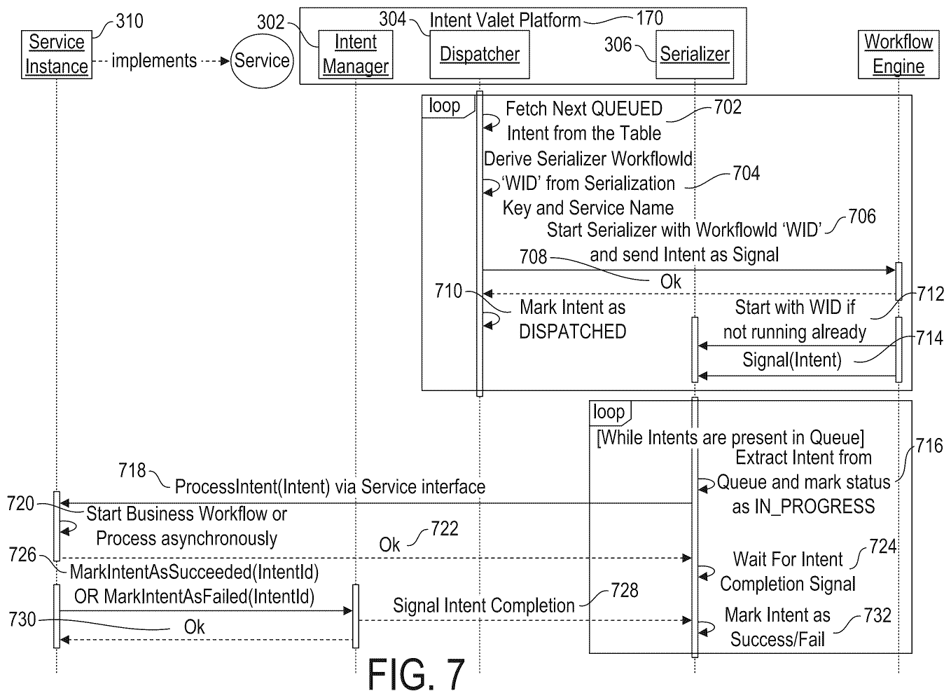

Turning now to FIG. 7, a sequence diagram of processing queued intents in the intent valet platform 170 in accordance with an embodiment of the invention is shown. As described in detail below, the sequence diagram highlights an internal chain of events and interactions that happen within the system when the submitted intent gets picked up by the intent valet platform. It all starts with the dispatcher 304 picking up a QUEUED intent in the context of the service for which the service is operating. Next, the object dependencies are identified by virtue of the serialization key and then the corresponding serializer 306 is started, if not running already. The dispatcher then delegates the intent for scheduling by submitting it to the queue of the serializer. The serializer then extracts the intent from the top of its queue, and forks into the service for business execution via the service interface, marking the intent as being in the IN_PROGRESS state. The service now starts the corresponding business workflow which may go on for few minutes to hours or even days. The serializer then waits for the intent completion notification from the service when business workflow concludes. Upon receiving this event from the service (via the intent manager interface), the serializer marks the intent as concluded (SUCCEEDED/FAILED/CANCELLED) and moves on to next waiting intent in its queue if any.

The intent processing as shown in FIG. 7 begins with a loop that includes steps 702-714. At step 702, the next queued intent is fetched from the intent table 308 by the dispatcher 304 of the intent valet platform 170. Next, at step 704, the serializer workflow ID (WID) is derived from the serialization key and the service name by the dispatcher.

Next, at step 706, an instruction is transmitted to the workflow engine to start the serializer 306 with the serializer WID and the intent is sent to the workflow engine as a signal by the dispatcher 304. Next, at step 708, an acknowledgement is transmitted to the dispatcher from the workflow engine. In response to the acknowledgement, the intent is marked as being in the DISPATCHED state by the dispatcher, at step 710.

Next, at step 712, the workflow engine starts the serializer with the WID if the serializer is not running already. Next, at step 714, the intent is transmitted to the serializer from the workflow engine as a signal.

Another loop, which involves steps 716-732, is then executed as long as intents are present in the queue of the serializer 306. This loop starts at step 716, where an intent is extracted from the queue and the status of the intent is marked as being in the IN_PROGRESS state by the serializer. Next, at step 718, an instruction is sent to the service instance 310 from the serializer via the service interface to process the extracted intent. In response, at step 720, a business workflow corresponding to the intent is started or the intent is otherwise processed asynchronously by the service instance. Next, at step 722, an acknowledgement is transmitted back to the serializer from the service instance in response to the instruction to process the intent. In response to the acknowledgement, a waiting status is entered by the serializer to wait for the intent completion signal, at step 724.

After the intent has been processed to a completion, a request with the intent ID is made to the intent manager 302 from the service instance 310 to mark the intent as “succeeded” or “failed” using MarkIntentAsSucceeded (IntentID) or MarkIntentAsFailed (IntentID), at step 726. In response, at step 728, an intent completion signal is transmitted to the serializer 306 from the intent manager. Next, at step 730, the intent is marked as success or failed by the serializer, i.e., as being in the SUCCEEDED state or in the FAILED state.

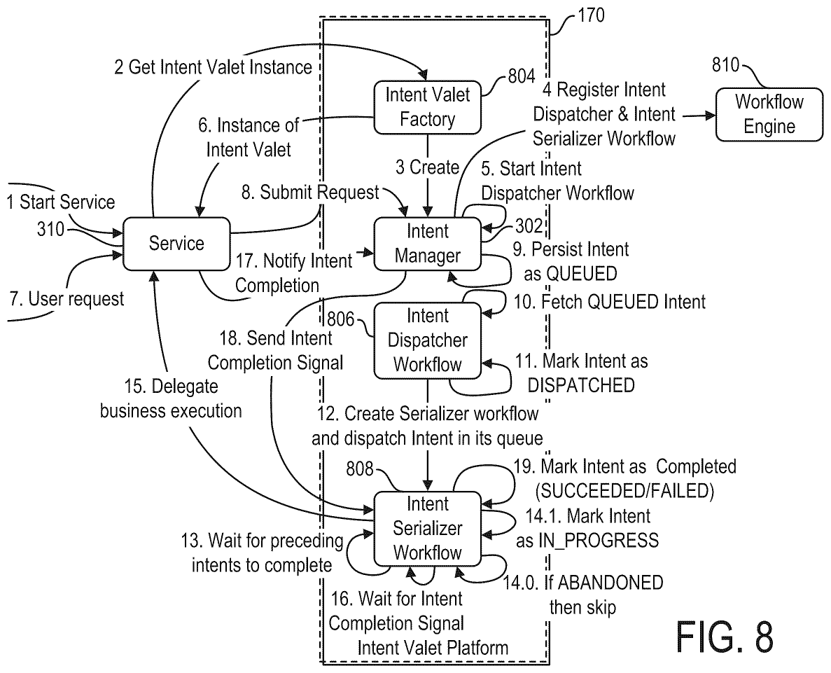

Turning now to FIG. 8, a diagram of an end-to-end event sequence of using the intent valet platform 170 in accordance with an embodiment of the invention is shown. As described below, the sequence diagram includes service starting a service, initializing the intent valet platform, accepting a request from the external world, admitting the request into the intent valet platform, scheduling for execution, delegating to the service for actual execution, and entering the terminal intent state.

The sequence diagram of FIG. 8 begins at step 1, where a service 802 is started. The service, which may be a microservice, may be started as part of an operation being executed in the HC director 160 or in any of the private and public cloud computing environments 102 and 104 in the cloud system 100. Next, at step 2, a get request for an intent valet instance is made to an intent valet factory 804 of the intent valet platform 170 by the service. Next, at step 3, a request to create an intent valet instance for the service is made to the intent manager 302 by the intent valet factory. In an embodiment, every microservice instance running inside or outside of the HC director 160 which leverages the intent valet platform 170 needs an instance of intent valet client-side components to interact with the intent valet platform system. The intent valet platform system manages a set of dispatcher workflows (described earlier) for each consuming services. The intent valet instance enables initializing required setup for the consuming service in the intent valet platform space. The intent valet factory enables reserving and initializing a pie of the intent valet platform service for the consuming microservices.

Next, at step 4, the intent dispatcher workflow 806 (i.e., the workflow of the dispatcher 304) and the intent serializer workflow 808 (i.e., the workflow of the serializer 306) is registered with a workflow engine 810 by the intent manager 302. Next, at step 5, the intent dispatcher workflow 806 is started by the intent manager. Next, at step 6, the intent valet instance is transmitted to the service 802 from the intent valet factory 804.

Next, at step 7, a user request is received at the service 802. In response, at step 8, the request is submitted to the intent manager 302 by the service. Next, at step 9, the intent is persisted in the intent table 308 as being in the QUEUED state by the intent manager.

Next, at step 10, the QUEUED intent in the intent table 308 is fetched by the intent dispatcher workflow 806. Next, at step 11, the intent is marked as being in the DISPATCHED state by the intent dispatcher workflow.

Next, at step 12, a serializer workflow is created and the intent is dispatched to its queue by the intent dispatcher workflow 806. Next, at step 13, a wait status is entered by the intent serializer workflow 808 to wait for the preceding intents to complete.

Next, at step 14.0, if the intent is now in the ABANDONED state, then the intent is skipped by the intent serializer workflow 808. If not, at step 14.1, the intent is marked as being in the IN_PROGRESS state by the intent serializer workflow.

Next, at step 15, the business execution associated with the intent is delegated to the service 802 by the intent serializer workflow 808. Next, at step 16, a waiting status is entered by the intent serializer workflow to wait for an intent completion signal.

Next, at step 17, a notification of intent completion is sent to the intent manager 302 from the service 802. In response, at step 18, an intent completion signal is sent to the intent serializer workflow 808 from the intent manager. Next, at step 19, the intent is marked by the intent serializer workflow as being completed, i.e., being in the SUCCEEDED state or the FAILED state, which completes the intent processing operation.

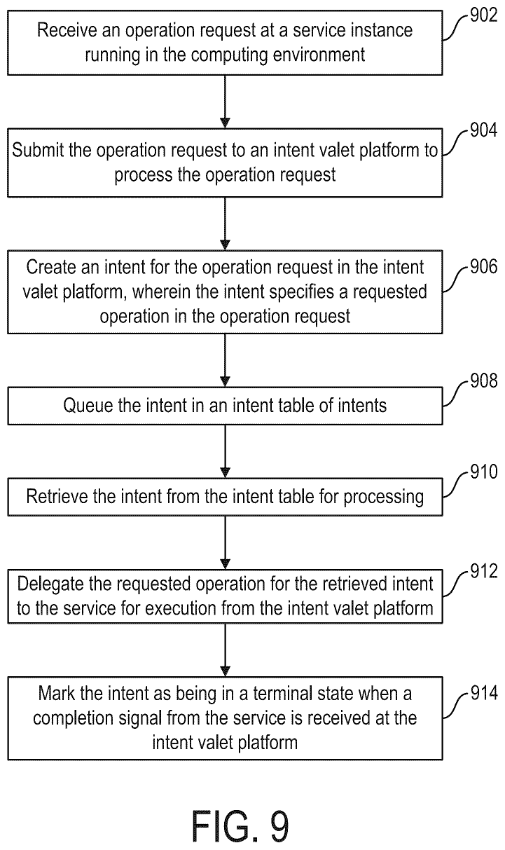

A computer-implemented method for processing operation requests in a computing environment, such as the cloud system 100, in accordance with an embodiment of the invention is described with reference to a process flow diagram of FIG. 9. At block 902, an operation request is received at a service instance running in the computing environment. At block 904, the operation request is submitted to an intent valet platform to process the operation request. At block 906, an intent for the operation request is created in the intent valet platform. The intent specifies a requested operation in the operation request. At block 908, the intent is queued in an intent table of intents. At block 910, the intent is retrieved from the intent table for processing. At block 912, the requested operation for the retrieved intent is delegated to the service for execution from the intent valet platform. At block 914, the intent is marked as being in a terminal state when a completion signal from the service is received at the intent valet platform.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

1. A computer-implemented method for processing operation requests in a computing environment, the method comprising:
receiving an operation request at a service instance running in the computing environment;
submitting the request to an intent valet platform to process the operation request;
creating an intent for the operation request in the intent valet platform, wherein the intent specifies a requested operation in the operation request;
queuing the intent in an intent table of intents;
retrieving the intent from the intent table for processing;
delegating the requested operation for the retrieved intent to the service for execution from the intent valet platform; and
marking the intent as being in a terminal state when a completion signal from the service is received at the intent valet platform.

2. The method of claim 1, wherein the intent includes an object dependency against which the requested operation is to be performed.

3. The method of claim 1, wherein retrieving the intent from the intent table for processing is executed by a dispatcher that is exclusively associated with the service.

4. The method of claim 1, wherein delegating the requested operation to the service for execution from the intent valet platform is executed by a serializer that serially processes conflicting intents that operate on one or more same objects.

5. The method of claim 1, wherein each of the intents in the intent table of intents is associated with a status state, the status state is a QUEUED state, a DISPATCHED state, an IN_PROGRESS state, a COMPLETED state, a CANCELLED state or a FAILED state.

6. The method of claim 5, wherein the intent is marked as being in the DISPATCHED state when the intent is retrieved from the intent table for processing.

7. The method of claim 1, further comprising creating multiple serializers to process the intents in the intent table, wherein each of the multiple serializers selects the intents with a same object dependency.

8. The method of claim 1, further comprising creating multiple dispatchers to process the intents in the intent table, wherein each of the multiple dispatchers operates for a single service.

9. A non-transitory computer-readable storage medium containing program instructions for processing operation requests in a computing environment, wherein execution of the program instructions by one or more processors causes the one or more processors to perform steps comprising:
receiving an operation request at a service instance running in the computing environment;
submitting the operation request to an intent valet platform to process the operation request;
creating an intent for the operation request in the intent valet platform, wherein the intent specifies a requested operation in the operation request;
queuing the intent in an intent table of intents;
retrieving the intent from the intent table for processing;
delegating the requested operation for the retrieved intent to the service for execution from the intent valet platform; and
marking the intent as being in a terminal state when a completion signal from the service is received at the intent valet platform.

10. The non-transitory computer-readable storage medium of claim 9, wherein the intent includes an object dependency against which the requested operation is to be performed.

11. The non-transitory computer-readable storage medium of claim 9, wherein retrieving the intent from the intent table for processing is executed by a dispatcher that is exclusively associated with the service.

12. The non-transitory computer-readable storage medium of claim 9, wherein delegating the requested operation to the service for execution from the intent valet platform is executed by a serializer that serially processes conflicting intents that operate on one or more same objects.

13. The non-transitory computer-readable storage medium of claim 9, wherein each of the intents in the intent table of intents is associated with a status state, the status state is a QUEUED state, a DISPATCHED state, an IN_PROGRESS state, a COMPLETED state, a CANCELLED state or a FAILED state.

14. The non-transitory computer-readable storage medium of claim 13, wherein the intent is marked as being in the DISPATCHED state when the intent is retrieved from the intent table for processing.

15. The non-transitory computer-readable storage medium of claim 9, wherein the steps further comprise creating multiple serializers to process the intents in the intent table, wherein each of the multiple serializers selects the intents with a same object dependency.

16. The non-transitory computer-readable storage medium of claim 9, wherein the steps further comprise creating multiple dispatchers to process the intents in the intent table, wherein each of the multiple dispatchers operates for a single service.

17. A system comprising:
memory; and
one or more processors configured to:
receive an operation request at a service instance running in a computing environment;
submit the operation request to an intent valet platform to process the operation request;
create an intent for the operation request in the intent valet platform, wherein the intent specifies a requested operation in the operation request;
queue the intent in an intent table of intents;
retrieve the intent from the intent table for processing;
delegate the requested operation for the retrieved intent to the service for execution from the intent valet platform; and
mark the intent as being in a terminal state when a completion signal from the service is received at the intent valet platform.

18. The system of claim 17, wherein the intent includes an object dependency against which the requested operation is to be performed.

19. The system of claim 17, wherein the intent is retrieved from the intent table for processing by a dispatcher that is exclusively associated with the service.

20. The system of claim 17, wherein the requested operation is delegated to the service for execution from the intent valet platform by serializer that serially processes conflicting intents that operate on one or more same objects.
